(19) United States
(12) Patent Application Publication
(10) Pub. No.: US 2010/0153174 A1
(43) Pub. Date: Jun. 17, 2010

(54) Generating Retail Cohorts From Retail Data

(75) Inventors: Robert Lee Angell, Salt Lake City, UT (US); Robert R. Friedlander, Southbury, CT (US); James R. Kraemer, Santa Fe, NM (US)

Correspondence Address: Stewart & Liu PLLC, PO Box 797277, Dallas, TX, 75379, US

(73) Assignee: INTERNATIONAL BUSINESS MACHINES CORPORATION, Armonk, NY (US)

(21) Appl. No.: 12/333,319

(22) Filed: Dec. 12, 2008

(51) Int. Cl. G06Q 10/00; G06Q 30/00

(52) U.S. Cl. 705/10

(57) ABSTRACT

The illustrative embodiments described herein provide a computer implemented method, apparatus, and computer program product for generating retail cohorts. In an illustrative embodiment, retail data derived from a population of retail customers is received and processed to form digital retail data. The digital retail data includes metadata describing a set of retail patterns associated with one or more customers in the population of retail customers. The set of retail patterns form a set of retail attributes for cohort generation. The digital retail data is analyzed using cohort criteria to identify a set of retail cohorts based on the set of retail attributes. The cohort criteria specify at least one retail attribute from the set of retail attributes for each cohort in the set of retail cohorts. Thereafter, a set of retail cohorts are generated. The retail cohorts have members selected from the population of retail customers, and have the at least one retail attribute in common.

### BACKGROUND OF THE INVENTION

1. Field of the Invention

The present invention relates generally to an improved data processing system and in particular to a method and apparatus for generating cohorts from retail data. Still more particularly, the present invention relates to a computer implemented method, apparatus, and computer program product for generating a set of retail cohorts having members selected from a population of retail customers observed at one or more retail facilities.

2. Description of the Related Art

A cohort is a group of members selected based upon a commonality of one or more attributes. For example, one attribute may be a level of education attained by employees. Thus, a cohort of employees in an office building may include members who have graduated from an institution of higher education. In addition, the cohort of employees may include one or more sub-cohorts that may be identified based upon additional attributes such as, for example, a type of degree attained a number of years the employee took to graduate, or any other conceivable attribute. In this example, such a cohort may be used by an employer to correlate an employee's level of education with job performance, intelligence, and/or any number of variables.

Cohorts are typically used to facilitate the study or analysis of its members over time. A cohort may be formed from one or more other cohorts. In addition, a cohort may be a subset of another cohort. The effectiveness of cohort studies depends upon a number of different factors, such as the length of time that the members are observed, and the ability to identify and capture relevant data for collection. For example, the information that is needed or wanted to identify attributes of potential members of a cohort may be voluminous, dynamically changing, unavailable, difficult to collect, and/or unknown to the members of the cohort and/or the user selecting members of the cohort. Moreover, it may be difficult, time consuming, or impractical for an individual to access all the information necessary to accurately generate cohorts. Thus, unique cohorts may be sub-optimal because individuals lack the skill, time, knowledge, and/or expertise needed to gather cohort attribute information from available sources.

Currently, the study of retail customers in a retail facility involves the collection of point of sale data through the use of customer loyalty programs. However, this method of study takes into consideration only the items purchased and the identity of the person who tenders the identification number or loyalty card. In other instances, retail data may be gathered by means of obtrusive surveys or controlled tests. Such research methods are inefficient, undesirable, and omit relevant components of retail data.

### SUMMARY OF THE INVENTION

The illustrative embodiments described herein provide a computer implemented method, apparatus, and computer program product for generating retail cohorts. In one embodiment, retail data derived from a population of retail customers is received and processed to form digital retail data. The digital retail data includes metadata describing a set of retail attributes associated with one or more customers in the population of retail customers. The set of retail patterns is used to form the set of retail attributes for cohort generation. The digital retail data is analyzed using cohort criteria to identify a set of retail cohorts based on the set of retail attributes. The cohort criteria specify at least one retail attribute from the set of retail attributes for each cohort in the set of retail cohorts. Thereafter, a set of retail cohorts are generated. The retail cohorts have members selected from the population of retail customers, and have the at least one retail attribute in common.

### BRIEF DESCRIPTION OF THE DRAWINGS

FIG. 1 is a pictorial representation of a network of data processing systems in which illustrative embodiments may be implemented;

FIG. 2 is a block diagram of a data processing system in which illustrative embodiments may be implemented;

FIG. 3 is a block diagram of a data processing system for generating retail cohorts in accordance with an illustrative embodiment;

FIG. 4 is a block diagram of retail data used for generating retail cohorts in accordance with an illustrative embodiment;

FIG. 5 is a block diagram of digital retail data in accordance with an illustrative embodiment;

FIG. 6 is a block diagram of a set of retail cohorts in accordance with an illustrative embodiment;

FIG. 7 is a flowchart of a process for generating retail cohorts in accordance with an illustrative embodiment;

FIG. 8 is a flowchart of a process for processing retail data in accordance with an illustrative embodiment; and

FIG. 9 is a flowchart of a process for generating retail cohorts from digital retail data in accordance with an illustrative embodiment.

### DETAILED DESCRIPTION OF THE PREFERRED EMBODIMENT

As will be appreciated by one skilled in the art, the present invention may be embodied as a system, method or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product embodied in any tangible medium of expression having computer usable program code embodied in the medium.

Any combination of one or more computer usable or computer readable medium(s) may be utilized. The computer-usable or computer-readable medium may be, for example but not limited to, an electronic, magnetic, optical, electromagnetic, infrared, or semiconductor system, apparatus, device, or propagation medium. More specific examples (a non-exhaustive list) of the computer-readable medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media such as those supporting the Internet or an intranet, or a magnetic storage device.

Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory. In the context of this document, a computer-usable or computer-readable medium may be any medium that can contain, store, communicate, propagate, or transport the program for use by or in connection with the instruction execution system, apparatus, or device. The computer-usable medium may include a propagated data signal with the computer-usable program code embodied therewith, either in baseband or as part of a carrier wave. The computer usable program code may be transmitted using any appropriate medium, including but not limited to wireless, wireline, optical fiber cable, RF, etc.

Computer program code for carrying out operations of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

The present invention is described below with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions.

These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flowchart and/or block diagram block or blocks.

The computer program instructions may also be loaded onto a computer or other programmable data processing apparatus to cause a series of operational steps to be performed on the computer or other programmable apparatus to produce a computer implemented process such that the instructions which execute on the computer or other programmable apparatus provide processes for implementing the functions/acts specified in the flowchart and/or block diagram block or blocks.

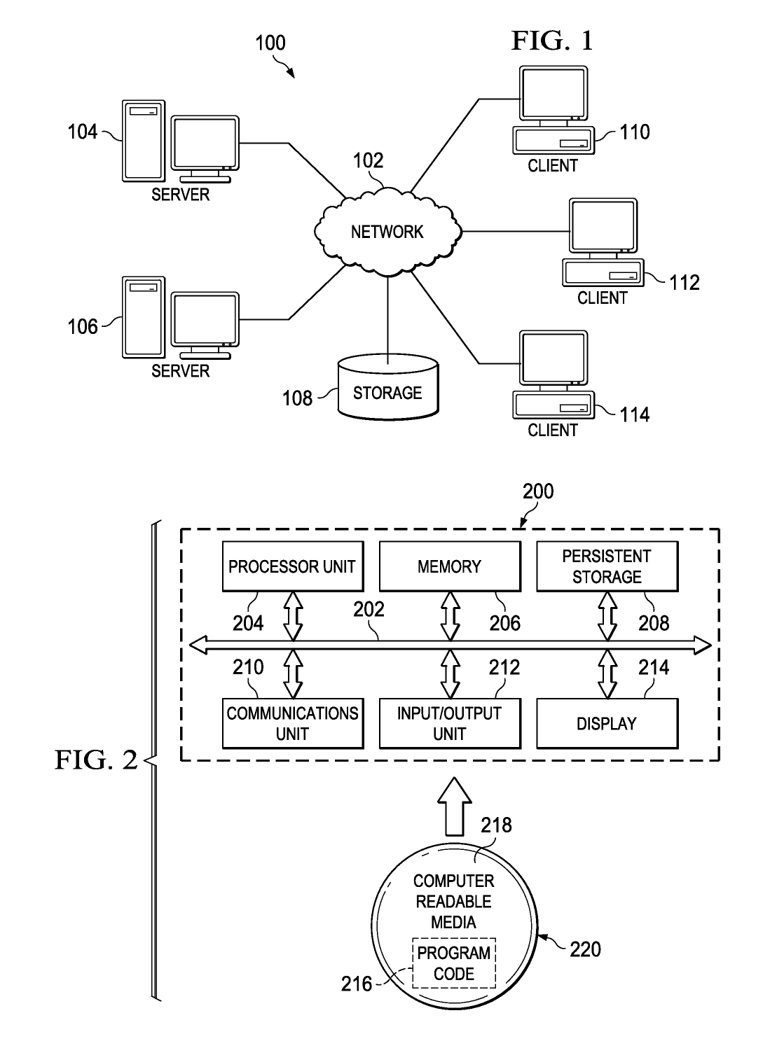

With reference now to the figures and in particular with reference to FIGS. 1-2, exemplary diagrams of data processing environments are provided in which illustrative embodiments may be implemented. It should be appreciated that FIGS. 1-2 are only exemplary and are not intended to assert or imply any limitation with regard to the environments in which different embodiments may be implemented. Many modifications to the depicted environments may be made.

FIG. 1 depicts a pictorial representation of a network of data processing systems in which illustrative embodiments may be implemented. Network data processing system 100 is a network of computers in which the illustrative embodiments may be implemented. Network data processing system 100 contains network 102, which is the medium used to provide communications links between various devices and computers connected together within network data processing system 100. Network 102 may include connections, such as wire, wireless communication links, or fiber optic cables.

In the depicted example, server 104 and server 106 connect to network 102 along with storage unit 108. In addition, clients 110, 112, and 114 connect to network 102. Clients 110, 112, and 114 may be, for example, personal computers or network computers. In the depicted example, server 104 provides data, such as boot files, operating system images, and applications to clients 110, 112, and 114. Clients 110, 112, and 114 are clients to server 104 in this example. Network data processing system 100 may include additional servers, clients, and other devices not shown.

In an illustrative example, a client computer, such as client 110, may host a retail pattern processing engine and a cohort generation engine for generating a set of retail cohorts. The retail cohorts may be formed from retail data for one or more retail customers selected from a population of retail customers at one or more retail facilities. The retail cohorts may be generated from retail data that includes at least one of retail facility event data and retail customer data. As used herein, the term “at least one of”, when used with a list of items, means that different combinations of one or more of the items may be used and only one of each item in the list may be needed. For example, “at least one of item A, item B, and item C” may include, for example, without limitation, item A, or item A and item B. This example also may include item A, item B, and item C, or item B and item C. Thus, the retail cohorts may be generated from retail facility event data, retail customer data, or both retail facility event data and retail customer data.

In addition, the client computer may also host an inference engine for generating inferences related to the set of retail cohorts. The inferences drawn from the set of retail cohorts may indicate, for example, purchasing patterns or habits demonstrated by retail customers who tend to spend more money at a retail facility. The inferences may then be used to increase revenue at a retail facility. In addition, the inferences may identify a selected set of retail attributes for achieving a retail objective. A retail objective is a goal associated with a retail facility, such as for example and without limitation, attracting a threshold number of retail customers, selling a predefined number of retail items, meeting a projected revenue stream, or any other goal. The inferences may identify relevant retail attributes for achieving the retail objective.

Program code located in network data processing system 100 may be stored on a computer recordable storage medium and downloaded to a data processing system or other device for use. For example, program code may be stored on a computer recordable storage medium on server 104 and downloaded to client 110 over network 102 for use on client 110.

In the depicted example, network data processing system 100 is the Internet with network 102 representing a worldwide collection of networks and gateways that use the Transmission Control Protocol/Internet Protocol (TCP/IP) suite of protocols to communicate with one another. At the heart of the Internet is a backbone of high-speed data communication lines between major nodes or host computers, consisting of thousands of commercial, governmental, educational and other computer systems that route data and messages. Of course, network data processing system 100 also may be implemented as a number of different types of networks, such as for example, an intranet, a local area network (LAN), or a wide area network (WAN). FIG. 1 is intended as an example, and not as an architectural limitation for the different illustrative embodiments.

With reference now to FIG. 2, a block diagram of a data processing system is shown in which illustrative embodiments may be implemented. Data processing system 200 is an example of a computer, such as server 104 or client 110 in FIG. 1, in which computer usable program code or instructions implementing the processes may be located for the illustrative embodiments. In this illustrative example, data processing system 200 includes communications fabric 202, which provides communications between processor unit 204, memory 206, persistent storage 208, communications unit 210, input/output (I/O) unit 212, and display 214.

Processor unit 204 serves to execute instructions for software that may be loaded into memory 206. Processor unit 204 may be a set of one or more processors or may be a multi-processor core, depending on the particular implementation. Further, processor unit 204 may be implemented using one or more heterogeneous processor systems in which a main processor is present with secondary processors on a single chip. As another illustrative example, processor unit 204 may be a symmetric multi-processor system containing multiple processors of the same type.

Memory 206 and persistent storage 208 are examples of storage devices. A storage device is any piece of hardware that is capable of storing information either on a temporary basis and/or a permanent basis. Memory 206, in these examples, may be, for example, a random access memory or any other suitable volatile or non-volatile storage device. Persistent storage 208 may take various forms depending on the particular implementation. For example, persistent storage 208 may contain one or more components or devices. For example, persistent storage 208 may be a hard drive, a flash memory, a rewritable optical disk, a rewritable magnetic tape, or some combination of the above. The media used by persistent storage 208 also may be removable. For example, a removable hard drive may be used for persistent storage 208.

Communications unit 210, in these examples, provides for communications with other data processing systems or devices. In these examples, communications unit 210 is a network interface card. Communications unit 210 may provide communications through the use of either or both physical and wireless communications links.

Input/output unit 212 allows for input and output of data with other devices that may be connected to data processing system 200. For example, input/output unit 212 may provide a connection for user input through a keyboard and mouse. Further, input/output unit 212 may send output to a printer. Display 214 provides a mechanism to display information to a user.

Instructions for the operating system and applications or programs are located on persistent storage 208. These instructions may be loaded into memory 206 for execution by processor unit 204. The processes of the different embodiments may be performed by processor unit 204 using computer implemented instructions, which may be located in a memory, such as memory 206. These instructions are referred to as program code, computer usable program code, or computer readable program code that may be read and executed by a processor in processor unit 204. The program code in the different embodiments may be embodied on different physical or tangible computer readable media, such as memory 206 or persistent storage 208.

Program code 216 is located in a functional form on computer readable media 218 that is selectively removable and may be loaded onto or transferred to data processing system 200 for execution by processor unit 204. Program code 216 and computer readable media 218 form computer program product 220 in these examples. In one example, computer readable media 218 may be in a tangible form, such as, for example, an optical or magnetic disc that is inserted or placed into a drive or other device that is part of persistent storage 208 for transfer onto a storage device, such as a hard drive that is part of persistent storage 208. In a tangible form, computer readable media 218 also may take the form of a persistent storage, such as a hard drive, a thumb drive, or a flash memory that is connected to data processing system 200. The tangible form of computer readable media 218 is also referred to as computer recordable storage media. In some instances, computer recordable media 218 may not be removable.

Alternatively, program code 216 may be transferred to data processing system 200 from computer readable media 218 through a communications link to communications unit 210 and/or through a connection to input/output unit 212. The communications link and/or the connection may be physical or wireless in the illustrative examples. The computer readable media also may take the form of non-tangible media, such as communications links or wireless transmissions containing the program code.

In some illustrative embodiments, program code 216 may be downloaded over a network to persistent storage 208 from another device or data processing system for use within data processing system 200. For instance, program code stored in a computer readable storage medium in a server data processing system may be downloaded over a network from the server to data processing system 200. The data processing system providing program code 216 may be a server computer, a client computer, or some other device capable of storing and transmitting program code 216.

The different components illustrated for data processing system 200 are not meant to provide architectural limitations to the manner in which different embodiments may be implemented. The different illustrative embodiments may be implemented in a data processing system including components in addition to or in place of those illustrated for data processing system 200. Other components shown in FIG. 2 can be varied from the illustrative examples shown.

As one example, a storage device in data processing system 200 is any hardware apparatus that may store data. Memory 206, persistent storage 208, and computer readable media 218 are examples of storage devices in a tangible form.

In another example, a bus system may be used to implement communications fabric 202 and may be comprised of one or more buses, such as a system bus or an input/output bus. Of course, the bus system may be implemented using any suitable type of architecture that provides for a transfer of data between different components or devices attached to the bus system. Additionally, a communications unit may include one or more devices used to transmit and receive data, such as a modem or a network adapter. Further, a memory may be, for example, memory 206 or a cache such as found in an interface and memory controller hub that may be present in communications fabric 202.

Retail data is data collected from retail customers relating to the purchase of retail items. For example, retail data may include retail customer data and retail facility event data. Retail customer data may include, for example, surveys, applications, questionnaires, or other sources of customer profile data provided by a retail customer or collected by a third party relating to particular customers. Retail facility event data may be collected by a set of sensors distributed throughout a retail facility. A retail facility is a facility selling retail items. Examples of retail facilities may include, without limitation, grocery stores, clothing stores, furniture stores, amusement parks, movie theaters, or any other location in which items may be bought or sold. The sensors present at the retail facility may monitor retail customers, retail facility employees, retail items, displays, or any other person, place, or object. Thus, the illustrative embodiments disclosed herein recognize that retail data formed from retail customer data and retail facility event data collected by a set of sensors deployed at a retail facility can be used to generate a set of retail cohorts having members sharing common attributes. Cohorts may be used in research, marketing, safety studies, and many other uses.

Therefore, in one embodiment of the present invention, a computer implemented method, apparatus, and computer program product is provided for generating retail cohorts. A retail cohort is a group of members who share one or more common retail attributes. Retail attributes are characteristics of retail customers that are often derived from a pattern of events present in retail facility event data, or a pattern of data present in retail customer data. The retail facility event data is captured by a set of sensors distributed throughout a retail facility. As used herein, the term “set” may refer to one or more. Thus, a set of sensors may be a set formed from a single sensor, or two or more sensors.

The set of sensors deployed in a retail facility captures retail facility event data which may be processed to identify a set of retail patterns. The retail facility event data, which is captured in an analog format, is processed and transformed into a digital format for use in a cohort generation engine. The cohort generation engine receives the digital retail data and generates cohorts from retail attributes present in the digital retail data. In one embodiment, the identified attributes are based on retail patterns in accordance with cohort criteria. Retail patterns may describe actions taken by retail customers, or retail items selected by retail customers. Thus, the set of retail attributes may be at least one of an action taken by the members of each retail cohort and a retail item associated with the members of the each retail cohort.

In one embodiment, the retail cohorts may be used in a system-wide monitoring process to quickly and efficiently pass vital information to a real-time computational process. In addition, once identified, retail attributes may be sufficient to identify members of a retail cohort. Thus, the embodiments described herein permit a user to create retail cohorts based on retail data for a population of retail customers or to identify customers from associated retail attributes.

The illustrative embodiments described herein provide a computer implemented method, apparatus, and computer program product for generating retail cohorts. In an illustrative embodiment, retail data derived from a population of retail customers is received and processed to form digital retail data. The digital retail data includes metadata describing a set of retail attributes associated with one or more customers in the population of retail customers. The set of retail patterns form a set of retail attributes for cohort generation. The digital retail data is analyzed using cohort criteria to identify a set of retail cohorts based on the set of retail attributes. The cohort criteria specify at least one retail attribute from the set of retail attributes for each cohort in the set of retail cohorts. Thereafter, a set of retail cohorts is generated. The retail cohorts have members selected from the population of retail customers. The members share at least one retail attribute in common.

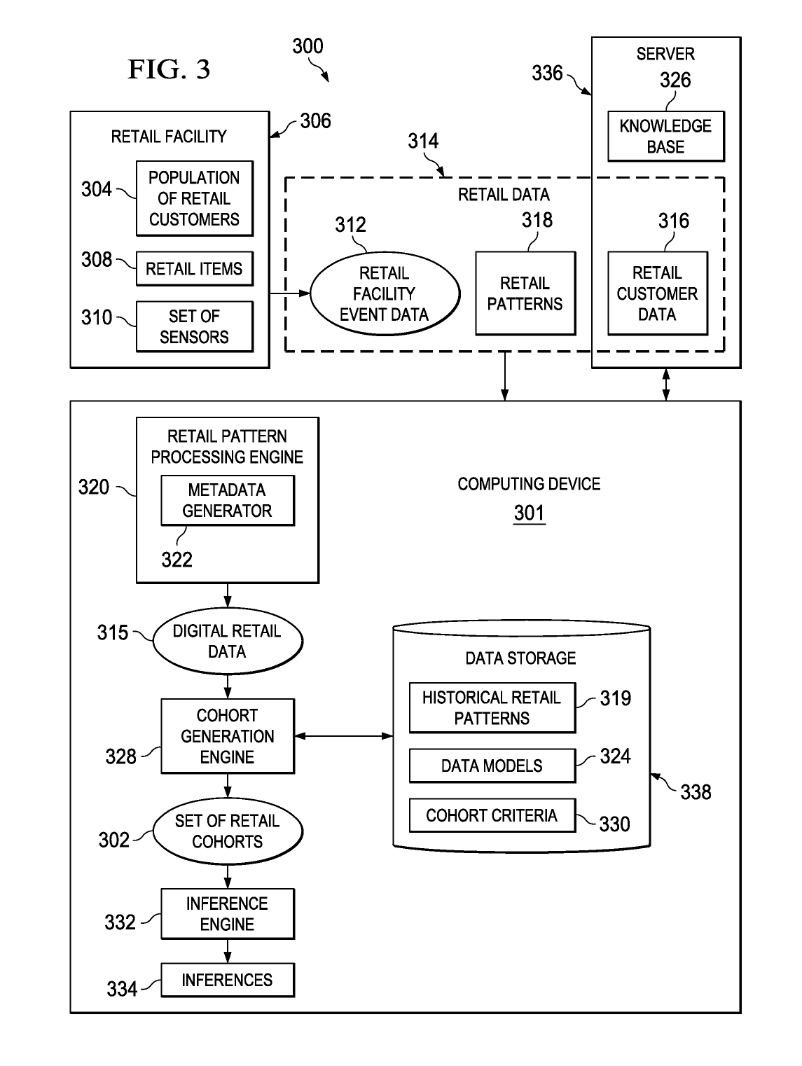

FIG. 3 is a block diagram of a data processing system for generating retail cohorts in accordance with an illustrative embodiment. Data processing system 300 is a data processing system, such as networked data processing system 100 in FIG. 1. In addition, computing device 301 of data processing system 300 may be implemented using any type of computing device, including, but not limited to, a main frame, a server, a personal computer, a laptop, a personal digital assistant (PDA), or any other computing device depicted in FIGS. 1 and 2.

Data processing system 300 is configured for generating set of retail cohorts 302. Set of retail cohorts 302 is one or more cohorts formed from retail customers having one or more common retail attribute(s). Retail customers who have been assigned to a cohort in set of retail cohorts 302 are also referred to as cohort members. Thus, examples of retail attributes that may be shared by members of set of retail cohorts 302 include, without limitation, an appearance of retail customers, an amount of money spent by retail customers, and a method of purchasing retail items. Thus, one cohort in set of retail cohorts 302 may include members who dress in a certain way. Another cohort in set of retail cohorts 302 may include members who spend at least a threshold amount of money. Yet another cohort in set of retail cohorts 302 may include members who purchase retail items using coupons.

Members of one retail cohort in set of retail cohorts 302 may also be members of a second retail cohort, if those members possess the requisite attribute or attributes for each cohort. Thus, a retail customer may be a member of a first retail cohort for retail customers who spend in excess of a threshold amount of money, and the retail customer may also be a member of a second retail cohort for retail customers who purchase retail items with coupons. In addition, more than one attribute may be used to identify a single cohort in set of retail cohorts 302. Thus, a third retail cohort may include members who spend a threshold amount of money and who purchase retail items with coupons. Retail customers who lack either one of the two attributes would then be placed into the first retail cohort or the second retail cohort.

The members of set of retail cohorts 302 are selected from population of retail customers 304. Population of retail customers 304 is comprised of individuals who are present at retail facility 306, or who have visited retail facility 306 for purchasing retail items 308. Retail items 308 are items for sale in a retail facility. Thus, if retail facility 306 is a grocery store, then retail items 308 may be fruits, vegetables, canned goods, frozen foods, beverages, or any other items offered for sale in the grocery store. Similarly, if retail facility 306 is a clothing store, then retail items 308 may be shirts, pants, ties, skirts, belts, shoes, or any other clothing items offered for sale in the clothing store. In addition, retail items 308 may be offered for sale in a location other than retail facility 306. For example, retail items 308 may be offered for sale in both retail facility 306 and for sale by an internet seller.

Population of retail customers 304 is monitored in retail facility 306 by set of sensors 310. Set of sensors 310 is one or more sensors distributed throughout retail facility 306. Set of sensors 310 may include, for example and without limitation, video cameras, audio sensors, pressure sensors, motion sensors, radio frequency identification tags and readers, temperature sensors, odor detectors, or any other currently available or later developed sensing device and/or data capture device. In addition to monitoring population of retail customers 304, set of sensors 310 may also monitor retail items 308, displays, pets, shopping carts, or any other object present within retail facility 306. Set of sensors 310 may also monitor temperature, odor, amount of light, or other ambient conditions present in retail facility 306.

Set of sensors 310 generates retail facility event data 312 from the monitoring of retail facility 306. Retail facility event data 312 is data describing events occurring within retail facility 306 and conditions present in retail facility 306. For example, retail facility event data 312 may include data captured by temperature sensors, humidity sensors, audio sensors, and light detectors. Thus, retail facility event data 312 may include data describing the conditions present within retail facility 306, such as temperature, humidity, sound, and light. In addition, retail facility event data 312 includes data captured by video cameras and tracking devices associated with retail items 308, such as radio frequency identification tags and readers. Thus, retail facility event data 312 may include data describing the appearance and actions of people, such as population of retail customers 304 present within retail facility 306. In addition, retail facility event data 312 may include data describing the selection of retail items 308 by population of retail customers 304.

Retail facility event data 312 is one component of retail data 314. Retail data 314 is all data related to the presence, actions, and tendencies of population of retail customers 304 either at retail facility 306 or other locations. Thus, retail data 314 may include, for example, data relating to the purchase of retail items 308 by population of retail customers 304, the frequency in which retail customers visit retail facility 306, the types of retail items that a particular retail customer prefers to buy, the days of the week that retail customers shop at retail facility 306, a type of payment tendered by retail customers in purchasing retail items 308, or any other data relating to population of retail customers 304.

Another component of retail data 314 is retail customer data 316. Retail customer data 316 is data associated with population of retail customers 304. For example, retail customer data 316 may include, for example, surveys, applications, questionnaires, or other sources of customer profile data provided by a retail customer or collected by a third party relating to particular customers.

Over time, as retail data 314 is aggregated, retail patterns 318 become detectable. Retail patterns 318 are patterns of data present in retail data 314 that relate to the habits and tendencies of population of retail customers 304 and/or the effect of conditions and events in retail facility 306 on the purchasing of retail items 308. For example, a retail pattern in retail patterns 318 may indicate that female shoppers prefer to visit a grocery store on Sunday afternoons, whereas male shoppers tend to shop on Thursday nights. Another retail pattern may show that shoppers visiting retail facility 306 wearing perfume tend to spend more money on each retail item, or that retail customers of a certain age group tend to pay with credit cards.

Retail patterns 318 are detected in retail data 314 by retail pattern processing engine 320. Retail pattern processing engine 320 is a software component for processing retail data 314 to form digital retail data 315. Digital retail data 315 is retail data 314 that has been processed and converted, if necessary, into digital format usable for generating set of retail cohorts 302. For example, facility event data 310 may be captured by set of sensors 308 in analog format. Thus, retail facility event data 312 may require conversion into digital format to be compatible with other software components for generating set of retail cohorts 302.

Retail pattern processing engine 320 includes metadata generator 322. Metadata generator 322 is a software component for generating metadata tags for identifying retail patterns 318. In one embodiment, metadata generator 322 generates metadata tags describing the data in retail data 314. Thereafter, retail pattern processing engine 320 references the metadata tags for identifying retail patterns 318. Once identified, individual retail patterns from retail patterns 318 may also serve as attributes upon which set of retail cohorts 302 may be based.

The processing of retail data 314 by retail pattern processing engine 320 identifies retail patterns 318 present in retail data 314. In one embodiment, retail pattern processing engine 320 identifies retail patterns 318 from retail data 314 by processing retail data 314 and any associated metadata tags generated by metadata generator 322 in data models 324. Data models 324 may be a set of one or more data models for processing retail data 314 for identifying retail patterns 318 that may then be used to form attributes for cohort generation. A data model is a model for structuring, defining, organizing, imposing limitations or constraints, and/or otherwise manipulating data or metadata to produce a result. A data model may be generated using any type of modeling method or simulation including, but not limited to, a statistical method, a data mining method, a causal model, a mathematical model, a marketing model, a behavioral model, a psychological model, a sociological model, or a simulation model.

In another embodiment, retail pattern processing engine 320 identifies the set of retail patterns by comparing retail data 314, including any metadata tags generated by metadata generator 322, to historical retail patterns 319. Historical retail patterns 319 are a set of one or more retail patterns encountered over time at retail facility 306. Thus, retail pattern processing engine 320 may process retail data 314 to identify retail patterns by comparing metadata tags present in retail data 314 with metadata tags associated with historical retail patterns 319. The comparison of retail data 314 to historical retail patterns 319, in this manner, enables retail pattern processing engine 320 to identify retail patterns for use in generating retail cohorts.

Retail patterns may also be identified by retail pattern processing engine 320 with reference to information present in knowledge base 326. Knowledge base 326 is a collection of facts, data, factors, and other information that may be used for, among other things, identifying retail patterns. For example, knowledge base 326 may include information, such as prices of retail items 308, locations from which retail items 308 may be bought other than in retail facility 306, retail facility locations, retail facility types, or other forms of information that may relate to retail facility 306, retail items 308, or population of retail customers 304. One example of a retail pattern that my be discovered by the reference of information stored in knowledge base 326 is the price range that population of retail customers 304 is willing to spend on retail items 308. Such information may also be paired with calendar information stored in knowledge base 326 to determine whether spending habits change with seasons of the year.

In particular, once a set of retail patterns is identified by retail pattern processing engine 320, metadata generator 322 generates metadata describing each retail pattern in retail patterns 318. Metadata generator 322 is a software component for generating metadata describing retail patterns present in retail data 314. Once identified, retail patterns 318, having metadata descriptors, may then serve as the attributes upon which retail cohorts from set of retail cohorts 302 may be based. Attributes are one or more characteristics, features, or other property shared by members of a retail cohort.

Retail pattern processing engine 320 sends digital retail data 315 to cohort generation engine 328 for generating set of retail cohorts 302. Cohort generation engine 328 is a software program that generates set of retail cohorts 302 from data received from digital retail data 315. In an alternate embodiment, cohort generation engine 328 may request digital retail data 315 from a data storage device, where digital retail data 315 is stored. In other embodiments, retail pattern processing engine 320 automatically sends digital retail data 315 to cohort generation engine 328 in real time, as digital retail data 315 is generated. In addition, another embodiment may have retail pattern processing engine 320 send digital retail data 315 to cohort generation engine 328 upon the occurrence of a predetermined event. The predetermined event may be the expiration time, the completion of a task, such as processing retail data 314, the occurrence of a timeout event, a user request, or any other predetermined event. Thus, the illustrative embodiments may utilize digital retail data 315 in real time as digital retail data 315 is generated. The illustrative embodiments may also utilize digital retail data that is pre-generated and/or stored in a data storage device until digital retail data 315 is retrieved at some later time.

Cohort generation engine 328 generates set of retail cohorts 302 with reference to cohort criteria 330. Cohort criteria 330 is a set of criteria and/or guidelines for generating set of retail cohorts 302. Cohort criteria 330 specifies a grouping of members into cohorts based upon the attributes present in digital retail data 315. For example, cohort criteria 330 may specify that set of retail cohorts 302 should include cohorts based on retail customer appearance. Consequently, cohort generation engine 328 will select only those members from population of retail customers 304 who share common appearance attributes. Retail attributes may be identified by comparing metadata associated with historical retail patterns 319.

In one embodiment, cohort generation engine 328 provides set of retail cohorts 302 to inference engine 332. Inference engine 332 is a software component, such as a computer program, that derives inferences 334 based upon input, such as set of retail cohorts 302. Inferences 334 are conclusions regarding possible future events or future changes in the attributes of cohorts that are drawn or inferred. Inferences 334 are derived in accordance with knowledge base 326. Knowledge base 326 is depicted as being stored in server 336, however, in other embodiments, knowledge base 326 may be stored in computing device 301, or any other data storage device, such as data storage 338. Data storage 338 is a device for storing data. Data storage 338 may be, for example, a portable computer diskette, a hard disk, a random access memory (RAM), a read-only memory (ROM), an erasable programmable read-only memory (EPROM or Flash memory), an optical fiber, a portable compact disc read-only memory (CDROM), an optical storage device, a transmission media, such as those supporting the Internet or an intranet, or a magnetic storage device. In an alternate embodiment, data storage 338 may be located in a remote location accessible to computing device 301 via a network, such as network 102 in FIG. 1.

Additionally, set of retail cohorts 302 may be analyzed by inference engine 332 to identify segments of population of retail customers 304 who would most likely purchase a newly developed retail item based upon historical retail patterns 319. For example, inference engine 332 may detect a retail pattern in historical retail patterns 319 that indicates a segment of population of retail customers 304 favors retail items having particular characteristics, such as packaging design or functionality. Thus, inference engine 332 may generate inferences 334 identifying likely characteristics that are associated with the increased sales of retail items. In addition, inference engine 332 may generate inferences 334 that suggest attributes that may be relevant for generating retail cohorts in set of retail cohorts 302. For example, inference engine 332 may generate inferences 334 describing the attributes that may be the most relevant for achieving a particular retail objective, such as increased revenues.

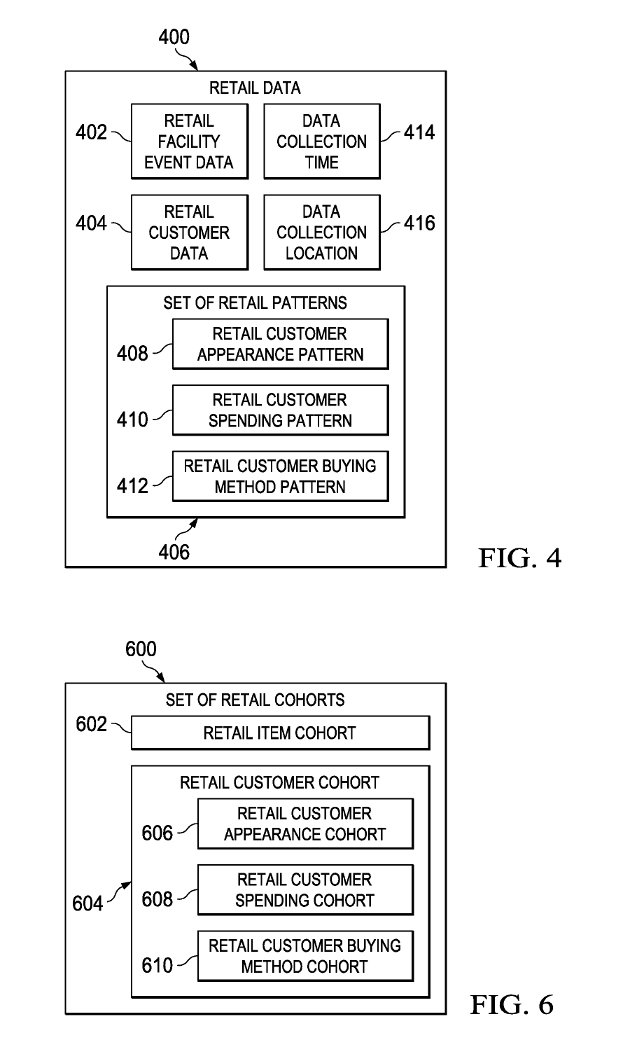

FIG. 4 is a block diagram of a retail data in accordance with an illustrative embodiment. Retail data 400 is retail data, such as retail data 314 in FIG. 3.

Retail data 400 includes retail facility event data 402 and retail customer data 404. Retail facility event data 402 is retail facility event data, such as retail facility event data 312 in FIG. 3. Similarly, retail customer data 404 is retail customer data, such as retail customer data 316 in FIG. 3. The processing of retail facility event data 402 and retail customer data 404 enables a retail pattern processing engine, such as retail pattern processing engine 320 in FIG. 3 to identify set of retail patterns 406. Set of retail patterns 406 is retail patterns, such as retail patterns 318 in FIG. 3.

In this illustrative example in FIG. 4, set of retail patterns 406 include retail customer appearance pattern 408. Retail customer appearance pattern 408 is one or more retail patterns based upon the appearance of retail customers in a population of retail customers. For example, retail facility event data 402 may include event data describing clothing styles worn by retail customers, hairstyles, or types of jewelry worn.

Set of retail patterns 406 also includes retail customer spending pattern 410. Retail customer spending pattern 410 is one or more retail patterns based upon the spending of money by retail customers. For example, retail customer spending pattern 410 may describe a frequency to which retail customers spend an amount of money in excess of a predefined threshold.

Retail customer buying method pattern 412 is another retail pattern included in set of retail patterns 406. Retail customer buying method pattern 412 is one or more retail patterns describing the method in which retail customers purchase retail items. For example, retail customer buying method pattern 412 may include patterns describing retail customers who tend to walk down every aisle of a grocery store, or retail customers who always stop at display shelves presenting retail items offered at a reduced price.

Retail data 400 also includes data collection time 414. Data collection time 414 is a data type indicating the date or time of day at which retail data 400 is collected. Retail data 400 may also include data collection location 416. Data collection location 416 is a data type indicating the location at which retail data 400 is collected.

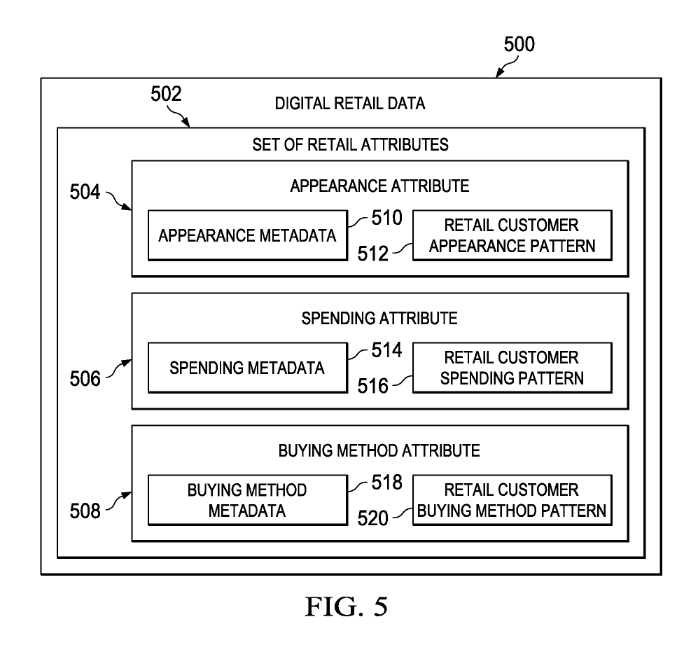

FIG. 5 is a block diagram of digital retail data in accordance with an illustrative embodiment. Digital retail data 500 is digital retail data, such as digital retail data 315 in FIG. 3. Digital retail data 500 includes data that may be processed to form set of retail attributes 502. Set of retail attributes 502 is one or more attributes upon which a set of retail cohorts may be generated. Set of retail attributes 502 includes appearance attribute 504, spending attribute 506, and buying method attribute 508. In an illustrative embodiment, set of retail attributes 502 is identified by a cohort generation engine, such as cohort generation engine 328 in FIG. 3, with reference to cohort criteria.

Appearance attribute 504 is an attribute identified using appearance metadata 510 describing retail customer appearance pattern 512. Appearance metadata 510 is metadata generated by a metadata generator, such as metadata generator 322 in FIG. 3, describing retail customer appearance pattern 512. Similarly, spending attribute 506 is a retail attribute identified using spending metadata 514 describing retail customer spending pattern 516. Likewise, buying method attribute 508 is an attribute identified using buying method metadata 518 describing retail customer buying method pattern 520.

FIG. 6 is a block diagram of a set of retail cohorts in accordance with an illustrative embodiment. Set of retail cohorts 600 is a set of retail cohorts, such as set of retail cohorts 302 in FIG. 3.

Set of retail cohorts 600 includes retail item cohort 602. Retail item cohort 602 is a cohort formed of members selected from a population of retail customers, such as population of retail customers 304 in FIG. 3. Retail item cohort 602 is one or more cohorts based on retail item attributes. Thus, members of retail item cohort 602 are grouped according to various retail items purchased by its members. For example, one cohort in retail item cohort 602 may include members of a population of retail customers who have purchased luxury vehicles. Another cohort in retail item cohort 602 may include members who have purchased motorcycles and/or other types of retail items.

Retail customer cohort 604 is another cohort in set of retail cohorts 600. In this example in FIG. 6, retail customer cohort 604 includes three cohorts. Retail customer appearance cohort 606 is a cohort of retail customer cohort 604 that is formed from retail customer appearance attributes. Retail customer appearance attributes may include attributes such as, for example, the type of clothing worn by a retail customer, whether the retail customer is well-groomed, whether the retail customer wears makeup, whether if the retail customer wears jewelry, or any other attribute associated with a retail customer's appearance.

Retail customer spending cohort 608 is a cohort of retail customer cohort 604. Retail customer spending cohort 608 is formed from spending attributes. For example, retail customers may be grouped according to an amount of money that a retail customer spends at a retail facility. Retail customer cohort 604 also includes retail customer buying method cohort 610. Retail customer buying method cohort 610 is a cohort of retail customer cohort 604 having members that are grouped based upon buying method attributes. For example, one buying method attribute may describe retail customers who walk down every aisle of the grocery store when making purchases. Another buying method attribute may describe retail customers who compare prices on every item placed into a shopping cart, whereas another buying method attribute may describe retail customers who only buy brand name retail items.

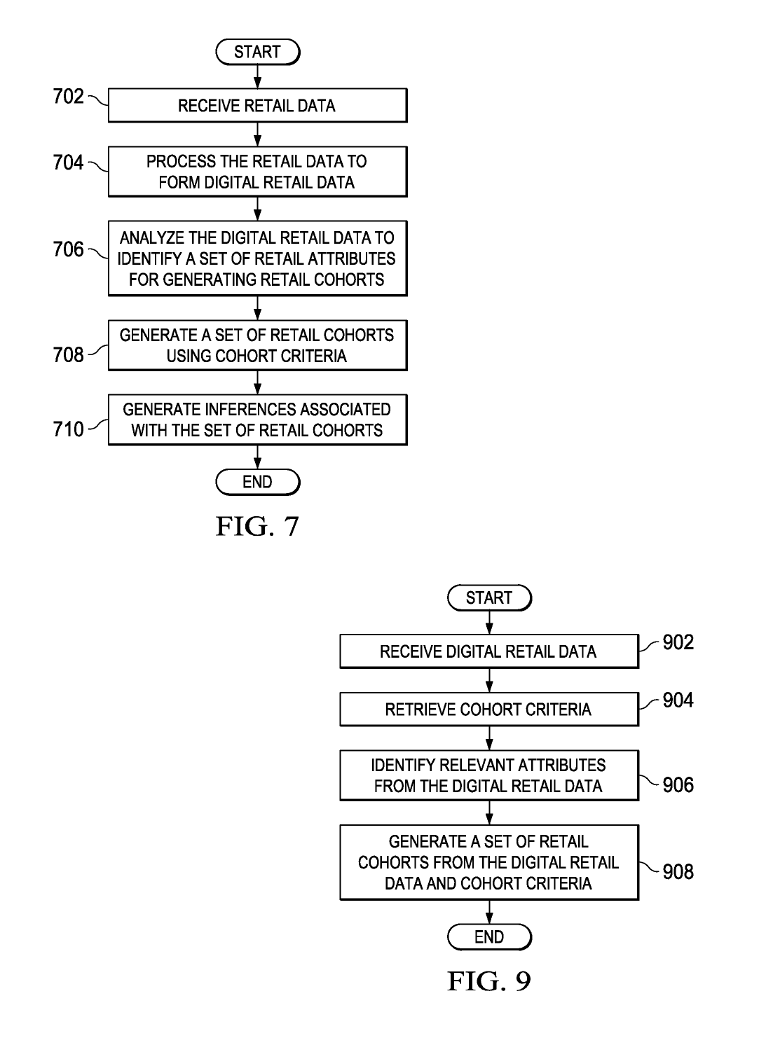

FIG. 7 is a flowchart of a process for generating retail cohorts in accordance with an illustrative embodiment. The process depicted in FIG. 7 may be implemented by software components of a computing device. For example, steps 702-706 may be implemented in a retail pattern processing engine, such as retail pattern processing engine 320 in FIG. 3. Step 708 may be implemented in a cohort generation engine, such as cohort generation engine 328 in FIG. 3. Step 710 may be implemented in an inference engine, such as inference engine 332 in FIG. 3.

The process begins by receiving retail data (step 702). The retail data is retail data, such as retail data 314 in FIG. 3. The retail data is processed to form digital retail data (step 704). Thereafter, the digital retail data is analyzed to identify a set of retail attributes for generating retail cohorts (step 706).

The process generates a set of retail cohorts using cohort criteria (step 708). Inferences associated with the set of retail cohorts may be generated (step 710) and the process terminates.

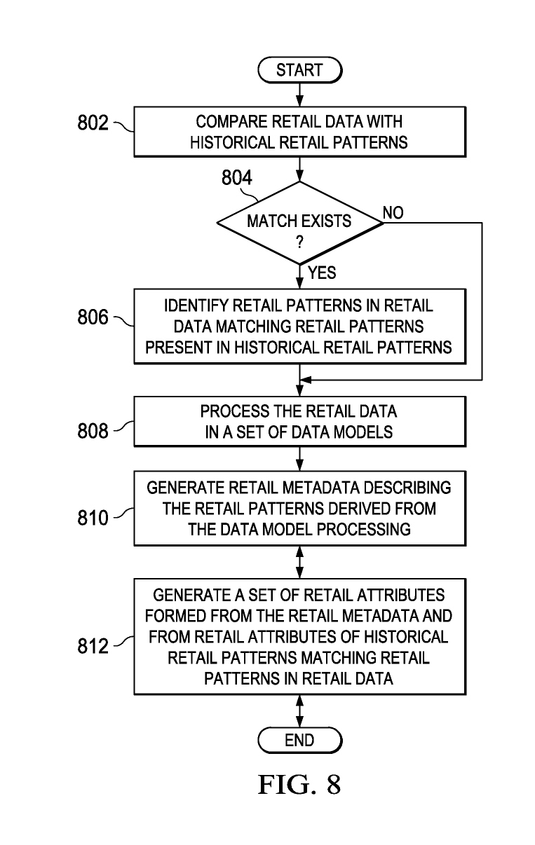

FIG. 8 is a flowchart of a process for processing retail data in accordance with an illustrative embodiment. The process depicted in FIG. 8 may be implemented in a software component, such as retail pattern processing engine 320 in FIG. 3.

The process begins by comparing retail data with historical retail patterns (step 802). In one embodiment, the process compares retail patterns in retail data with historical retail patterns. In another embodiment, the process compares metadata describing retail patterns in retail data with metadata associated with historical retail patterns.

The process then makes the determination as to whether a match exists (step 804). If the process makes the determination that a match exists, the process identifies retail patterns in retail data that match retail patterns present in historical retail patterns (step 806). The retail data is also processed in a set of data models (step 808), such as data models 324 in FIG. 3. In one embodiment, processing of the retail data in the set of data models identifies retail patterns. The process generates retail metadata describing the retail patterns derived from the data model processing (step 810). The process then generates a set of retail attributes formed from the retail metadata and from the retail attributes of the historical retail patterns which match retail patterns in retail data (step 812). The process terminates thereafter.

Returning to step 804, if the process makes the determination that no match exists between the retail data and the historical retail patterns, then the process continues to step 808.

FIG. 9 is a flowchart of a process for generating retail cohorts from digital retail data in accordance with an illustrative embodiment. The process depicted in FIG. 9 may be implemented in a software component, such as cohort generation engine 328 in FIG. 3.

The process begins by receiving digital retail data (step 902). The digital retail data is digital retail data, such as digital retail data 315 in FIG. 3. The process then retrieves cohort criteria (step 904). Cohort criteria, such as cohort criteria 330 in FIG. 3, specifies guidelines for creating a set of retail cohorts, such as, for example, relevant retail attributes from the set of retail attributes for generating set of retail cohorts.

The process identifies relevant attributes from the digital retail data (step 906). In one embodiment, the attributes in the digital retail data are derived from the set of retail patterns originally present in the retail data. Thereafter, the process generates a set of retail cohorts from the digital retail data and the cohort criteria (step 908), and the process terminates.

Thus, the illustrative embodiments described herein provide a computer implemented method, apparatus, and computer program product for generating retail cohorts. In one embodiment, retail patterns for a population of retail customers are identified from retail data including retail facility event data and retail customer data. Retail attributes are identified and a set of retail cohorts is generated.

The retail cohorts generated by the method and apparatus disclosed above enable the grouping of members into cohorts having similar attributes. Once formed, the retail cohorts may then be included in a system-wide monitoring process to quickly and efficiently pass vital information to a real-time computational process. The generation of retail cohorts in the manner described above obviates the need for manual selection of cohort attributes, thereby allowing the generation of more robust retail cohorts. Once formed, the retail cohorts may be used, for example and without limitation, for marketing research, public health, demographic research, and safety and/or security applications.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular embodiments only and is not intended to be limiting of the invention. As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiment was chosen and described in order to best explain the principles of the invention and the practical application, and to enable others of ordinary skill in the art to understand the invention for various embodiments with various modifications as are suited to the particular use contemplated.

The invention can take the form of an entirely hardware embodiment, an entirely software embodiment or an embodiment containing both hardware and software elements. In a preferred embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any tangible apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid-state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories, which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

The description of the present invention has been presented for purposes of illustration and description, and is not intended to be exhaustive or limited to the invention in the form disclosed. Many modifications and variations will be apparent to those of ordinary skill in the art. The embodiment was chosen and described in order to best explain the principles of the invention, the practical application, and to enable others of ordinary skill in the art to understand the invention for various embodiments with various modifications as are suited to the particular use contemplated.

What is claimed is:

1. A computer implemented method for generating retail cohorts, the computer implemented method comprising:
responsive to receiving retail data derived from a plurality of retail customers, processing the retail data to form digital retail data, wherein the digital retail data comprises metadata describing a set of retail patterns associated with one or more customers in the plurality of retail customers, and wherein the set of retail patterns form a set of retail attributes for cohort generation;
analyzing the digital retail data using cohort criteria to identify a set of retail cohorts based on the set of retail attributes, wherein the cohort criteria specifies at least one retail attribute from the set of retail attributes for each cohort in the set of retail cohorts; and
generating the set of retail cohorts, wherein each member of the set of retail cohorts is selected from the plurality of retail customers, wherein the each member of a cohort in the set of retail cohorts has the at least one retail attribute in common.

2. The computer implemented method of claim 1 further comprising:
identifying each member of the set of retail cohorts based on an analysis of the set of retail attributes.

3. The computer implemented method of claim 1, wherein analyzing the digital retail data comprises at least one of analyzing the digital retail data using historical retail patterns and analyzing the digital retail data with a set of data models.

4. The computer implemented method of claim 1, wherein processing the retail data further comprises:
generating the metadata describing the retail data, wherein the metadata are used for identifying the set of retail patterns.

5. The computer implemented method of claim 1 further comprising:
updating historical retail patterns with the set of retail patterns present in the retail data.

6. The computer implemented method of claim 1 further comprising:
generating inferences based on the set of retail cohorts, wherein the inferences specify a selected set of retail attributes for achieving retail objectives.

7. The computer implemented method of claim 1, wherein the set of retail attributes comprises at least one of an action taken by the members of each retail cohort and a retail item associated with the members of the each retail cohort.

8. A computer program product for generating retail cohorts, the computer program product comprising:
a computer recordable-type medium;
first program instructions for processing retail data to form digital retail data in response to receiving the retail data derived from a plurality of retail customers, wherein the digital retail data comprises metadata describing a set of retail patterns associated with one or more customers in the plurality of retail customers, and wherein the set of retail patterns form a set of retail attributes for cohort generation;
second program instructions for analyzing the digital retail data using cohort criteria to identify a set of retail cohorts based on the set of retail attributes, wherein the cohort criteria specifies at least one retail attribute from the set of retail attributes for each cohort in the set of retail cohorts;
third program instructions for generating the set of retail cohorts comprising members selected from the plurality of retail customers, wherein each member of a cohort in the set of retail cohorts has the at least one retail attribute in common; and
wherein the first program instructions, the second program instructions, and the third program instructions are stored on the computer recordable-type medium.

9. The computer program product of claim 8, further comprising:
fourth program instructions for identifying each member of the set of retail cohorts based on the set of retail attributes, and wherein the fourth program instructions are stored on the computer recordable-type medium.

10. The computer program product of claim 8, wherein the second program instructions further comprises instructions for at least one of analyzing the digital retail data using historical retail patterns and analyzing the digital retail data with a set of data models.

11. The computer program product of claim 8, wherein the first program instructions further comprises instructions for generating the metadata describing the retail data, wherein the metadata are used for identifying the set of retail patterns.

12. The computer program product of claim 8 further comprising:
fifth program instructions for updating historical retail patterns with the set of retail patterns present in the retail data, and wherein the fifth program instructions are stored on the computer recordable-type medium.

13. The computer program product of claim 8 further comprising:
sixth program instructions for generating inferences based on the set of retail cohorts, wherein the inferences specify a selected set of retail attributes for achieving retail objectives, and wherein the sixth program instructions are stored on the computer recordable-type medium.

14. The computer program product of claim 8, wherein the set of retail attributes comprises at least one of an action taken by the members of each retail cohort and a retail item associated with the members of the each retail cohort.

15. An apparatus for generating retail cohorts, the apparatus comprising:
a bus system;
a memory connected to the bus system, wherein the memory includes computer usable program code; and
a processing unit connected to the bus system, wherein the processing unit executes the computer usable program code to process retail data to form digital retail data in response to receiving the retail data derived from a plurality of retail customers, wherein the digital retail data comprises metadata describing a set of retail patterns associated with one or more customers in the plurality of retail customers, and wherein the set of retail patterns form a set of retail attributes for cohort generation; analyze the digital retail data using cohort criteria to identify a set of retail cohorts based on the set of retail attributes, wherein the cohort criteria specifies at least one retail attribute from the set of retail attributes for each cohort in the set of retail cohorts; and generate the set of retail cohorts comprising members selected from the plurality of retail customers, wherein each member of a cohort in the set of retail cohorts has the at least one retail attribute in common.

16. The computer implemented method of claim 15, wherein the processing unit further executes the computer usable program code to analyze the digital retail data using at least one of historical retail patterns and a set of data models.

17. The computer implemented method of claim 15, wherein the processing unit further executes the computer usable program code to update historical retail patterns with the set of retail patterns present in the retail data.

18. The apparatus of claim 15, wherein the processing unit further executes the computer usable program code to generate inferences based on the set of retail cohorts, wherein the inferences specify the set of retail attributes for achieving retail objectives.

19. A system for generating retail cohorts, the system comprising:
a set of sensors, wherein the set of sensors captures retail data, and wherein the retail data comprises a set of retail patterns;
a retail pattern processing engine, wherein the retail pattern processing engine forms digital retail data from the retail data; and
a cohort generation engine, wherein the cohort generation engine generates a set of retail cohorts from the digital retail data, wherein each member in the set of retail cohorts share at least one retail attribute in common.

20. The system of claim 19, further comprising:
an inference engine, wherein the inference engine generates inferences based on the set of retail cohorts, wherein the inferences specify a selected set of retail attributes for achieving retail objectives.
